(19) United States
(12) Patent Application Publication
(10) Pub. No.: US 2009/0104454 A1
(43) Pub. Date: Apr. 23, 2009

(54) Manufacture of Large Articles in Synthetic Vitreous Silica

(75) Inventor: Ian George Sayce, Northumberland (GB)

Correspondence Address: HOWSON & HOWSON LLP, 501 OFFICE CENTER DRIVE, SUITE 210, FORT WASHINGTON, PA, 19034, US

(73) Assignee: SAINT-GOBAIN QUARTZ PLC, Tyne & Wear (GB)

(21) Appl. No.: 12/282,783

(22) PCT Filed: Mar. 15, 2007
(86) PCT No.: PCT/GB2007/000925

§ 371 Date: Dec. 17, 2008

(30) Foreign Application Priority Data
Mar. 17, 2006 (GB) 0605461.3

(51) Int. Cl. C03B 32/00; G02B 1/00; B32B 17/00

(52) U.S. Cl. 428/426; 65/32.1; 65/32.5

(57) ABSTRACT

A process for the manufacture of a substantially bubble-free article of synthetic vitreous silica free from localised variations in refractive index (striae) and suitable for optical applications, wherein an ingot of synthetic vitreous silica containing unacceptable bubbles is submitted to a first heat treatment process consisting of hot isostatic pressing at a temperature in the range 1,250° C. to 1,500° C. at a pressure in the range 10 MPa to 250 MPa, followed by a second heat treatment process at a pressure in the range 0.01 to 1 MPa and at a temperature in the range 1,550° C. to 1,850° C.

The present invention relates to the production of large substantially bubble-free articles from synthetic vitreous silica glass. In particular, the invention relates to the production of vitreous silica articles for use in optical applications, for example as windows, as lenses or as photomasks or use in the semiconductor industry.

Large sized synthetic vitreous silica products are sought by the semiconductor and other industries and for the most demanding applications these are required to have no bubbles or inclusions, and to have excellent optical quality, notably good refractive index homogeneity and good UV transmission. For some applications, the articles also need to have good resistance to solarisation (darkening), even after use with high energy radiation in the vacuum ultraviolet, e.g. from excimer lasers at wavelengths such as 248 nm (KrF laser) and 193 nm (ArF laser).

The required glasses are typically made by vapour deposition processes, from an appropriate volatile silicon-containing precursor. Suitable precursors include halosilanes (e.g. silicon tetrachloride), alkoxysilanes (e.g. methyltrimethoxysilane, MTMS), and siloxanes (e.g. octamethylcyclotetrasiloxane, OMCTS). Such a precursor compound is fed to a flame or plasma, in which it is converted by oxidation or hydrolysis to ultrafine particles of silica. These particles are collected on a substrate, either at high temperature, when they sinter directly to transparent glass (the direct deposition process) or at lower temperature, when they accumulate as a porous “soot body” which may be subsequently consolidated into a transparent glass by sintering at high temperature in helium or under vacuum (the two-stage process). As part of the latter process the soot body may be heated in a chlorine-containing atmosphere prior to consolidation in order to dehydrate and purify the product.

Direct deposition processes have the advantage that large ingots may be manufactured with acceptable economy, and by suitable choice of deposition conditions it is possible to incorporate controlled levels of hydrogen during the deposition process. Such hydrogen-doped glass has been found to be resistant to darkening under the influence of UV irradiation, which means that the glass exhibits a prolonged lifetime in critical applications involving intense UV irradiation. Glasses having hydrogen levels in the range 10¹⁶ to 10¹⁹ molecules/cm³ are typically produced in this way.

The precise mechanism of hydrogen incorporation during deposition is unclear. It may arise from hydrogen-containing species in the flame, which is typically an oxy-hydrogen or oxy-methane (i.e. natural gas) flame, or it may arise from the precursor when this is an organosilicon compound. Whatever the mechanism, however, the glass has a tendency, on cooling, to be supersaturated with hydrogen, often to the extent that, were such levels to be achieved by hydrogen doping of previously formed glass, it would be necessary to immerse the glass article in hydrogen within an autoclave at high pressure and temperature over a prolonged period.

The high degree of supersaturation of hydrogen which can exist in the glass during deposition at atmospheric pressure gives rise to a problem during deposition. If particles of dust (e.g. soot particles falling from the roof or wall of the furnace) strike the hot deposition surface of the ingot, they may nucleate micro-bubbles. Furthermore, because the glass near the ingot surface remains at high temperature for a prolonged period, as the ingot is withdrawn slowly from the hot zone, these micro-bubbles can continue to grow to substantial size due to ex-solution of hydrogen, until further growth is eventually prevented by the “freezing” of the glass. Such bubbles are unacceptable in the final product. Indeed, depending on the size of the eventual product or products to be manufactured from a given ingot, one or more bubbles may dramatically reduce the yield of useful product from the ingot.

This problem becomes increasingly serious as the size of a given ingot, or of the product to be made therefrom, increases. Thus it is relatively easy to manufacture a high quality bubble-free vitreous silica article of small dimensions, but as the size of an ingot or product to be made therefrom increases, so does the risk of incorporating one or more bubbles, and it becomes progressively more difficult reliably and repeatedly to generate a bubble-free article. A typical large ingot of today's production may have a diameter (after machining to remove the crust of unacceptable material) of over 400 mm and a total weight of over 200 kg, while ingots of even larger size, e.g. diameter of over 500 mm, and total weight of over 350 kg, may be manufactured. The deposition process to make such large ingots lasts for many days, and it becomes very difficult to guarantee total absence of bubble-causing defects in the course of making such a large body of synthetic vitreous silica.

On the other hand there exist very demanding applications for large items fabricated from synthetic vitreous silica, for example large windows, large lenses, and the large photomask substrates used to generate the integrated circuits and filters which are incorporated in LCD display screens. The current generation of LCD photomask substrate plates have unit weights of typically 26 kg or as much as 49 kg today, and still larger unit weights will be required in the future. Such items require good optical quality and total absence of any bubbles, and the manufacture of the parent glass ingots entirely free from bubbles presents a severe technical challenge.

While every effort should be made to eliminate the causes of such bubbles, there remains a risk that one or more bubbles may be formed during the deposition process. There is therefore a need to find means to eliminate any bubbles after deposition. A known method of achieving bubble removal is hot isostatic pressing, wherein a vitreous silica ingot may be held at high temperature in an autoclave under high pressure of inert gas of low solubility (e.g. argon) for sufficient time to permit collapse and total dissolution of any contained bubbles (as described, for example, in U.S. Pat. No. 4,414,014). This process is commonly known as hot isostatic pressing (HIP).

This process has been used, for example, to eliminate small bubbles from flame-fused vitreous silica, to be used to make substrate and cladding tubes for optical fibre manufacture. However, when the process is applied to the relatively large bubbles present in synthetic vitreous silica made by the direct deposition process, it has been found that the product glass exhibits unacceptable stress birefringence and inhomogeneity of refractive index in the region of the collapsed bubbles. For this reason, hot isostatic pressing has proved inadequate for the removal of large bubbles from direct-deposited synthetic vitreous silica.

The inclusion of relatively small bubbles is also a problem in synthetic vitreous silica glasses made by the two-stage “soot and sinter” processes, due to the trapping of gas during the sintering (consolidation) stage. HIP treatment can be used to eliminate these bubbles, but this leaves the glass in a densified state, wherein there may be refractive index inhomogeneities in the glass, rendering it unsuitable for refined optical applications.

The object of the present invention is to provide means for overcoming the above difficulties. As a result of recent investigations it has been found that if, following a hot isostatic pressing treatment to remove bubbles, the ingot is subjected to a further heat treatment at substantially higher temperature, the observed local birefringence and refractive index inhomogeneity may be dramatically reduced or even eliminated. Furthermore the improvement is aided substantially if the secondary heat treatment is such as to permit some flow of the glass, as for example during the slumping or reshaping (moulding) of the softened glass to give a product of substantially different dimensions or shape from those of the original ingot (for example the reshaping of a cylindrical ingot to give a cylindrical product of larger diameter or to give a square or rectangular product).

The invention provides, in one aspect, a process for the manufacture of a substantially bubble-free article of synthetic vitreous silica, free from localised variations in refractive index (striae) and suitable for optical applications, wherein an ingot of synthetic vitreous silica containing unacceptable bubbles is submitted to a first heat treatment process consisting of hot isostatic pressing at a temperature in the range 1,250° C. to 1,500° C. at a pressure in the range 10 MPa to 250 MPa, followed by a second heat treatment process at a lower pressure and at a temperature in the range 1,550° C. to 1,850° C. Preferably, the first heat treatment process is carried out at a pressure in the range 50 to 120 MPa.

Preferably, the second heat treatment process involves some flow or reshaping of the ingot, but acceptable results may also be achieved by secondary heat treatment involving minimal flow.

In preferred embodiments, the secondary heat treatment takes place under an inert gas atmosphere at a pressure in the range 0.01 to 1 MPa.

The ingot weight, prior to hot isostatic pressing, may be, for example more than 100 kg, more than 200 kg, or even more than 300 kg.

The invention also extends to a substantially bubble-free article of synthetic vitreous silica, produced by any one of the methods described herein.

Alternatively, the invention provides a substantially bubble-free article of synthetic vitreous silica free from localised variations in refractive index (striae) and suitable for optical applications, manufactured by submitting an ingot of synthetic vitreous silica containing unacceptable bubbles to a first heat treatment process consisting of hot isostatic pressing at a temperature in the range 1,250° C. to 1,500° C. at a pressure in the range 10 MPa to 250 MPa, followed by a second heat treatment process at a pressure in the range 0.01 to 1 MPa and at a temperature in the range 1,550° C. to 1,850° C. Preferably, the first heat treatment process is carried out at a pressure in the range 50 to 120 MPa.

In a further alternative aspect, the invention provides a substantially bubble-free article of synthetic vitreous silica, free from localised variations in refractive index (striae) and suitable for optical applications, formed from a hot isostatically pressed ingot which has been subjected to a second heat treatment process at higher temperatures.

The article may, for example, be an optical component such as a window, a lens, or a photomask substrate plate, of weight more than 25 kg, preferably more than 35 kg, and most preferably more than 45 kg.

The invention is hereinafter described in more detail by way of illustration only, by way of the following practical examples.

### EXAMPLE 1

An ingot of synthetic vitreous silica was made by the direct deposition process, by oxidation of octamethylcyclotetrasiloxane (OMCTS) in an oxy-hydrogen flame. On withdrawing the ingot from the furnace it was found to have dimensions 350 mm diameter and 800 mm length, and to contain a number of bubbles of diameter in the range 10-20 mm. The ingot was machined to remove the external crust and a section of diameter 305 mm and length 630 mm (weight 102 kg) was thoroughly cleaned and subjected to a hot isostatic pressing process comprising heating to a temperature of 1,450° C. at pressure of 90 MPa in an argon atmosphere for a period of 60 minutes, followed by accelerated cooling to a temperature of 1,050° C. and subsequent slow cooling to a temperature of 500° C. On removal from the furnace some superficial devitrification was observed, which was removed by grinding.

On examining the ingot, the bubbles were no longer visible. However, subsequent measurement of the refractive index homogeneity of a section of the ingot using an interferometer showed clear evidence of the former bubbles with a sharp change in refractive index near the edges of the zones previously occupied by bubbles. The ingot was thus unsuitable for high quality optical applications.

### EXAMPLE 2

A second bubble-containing ingot was prepared by the direct deposition process as in Example 1. This was treated by hot isostatic pressing at 1,400° C. at pressure of 104 MPa for a period of 90 minutes to remove the contained bubbles. The ingot was then machined to remove superficial devitrification, to produce a cylindrical body of dimensions diameter 320 mm and length 790 mm (weight 140 kg). The ingot was thoroughly cleaned and placed in a high temperature furnace in a high purity graphite mould of internal diameter 325 mm (chosen to prevent substantial slumping or flow). The internal surface of the mould was coated with high purity silicon carbide powder, of −80 US mesh to prevent adhesion of the silica to the graphite, and facilitate removal of the silica after processing. The furnace was evacuated and re-filled with argon, and then heated to a temperature of 1,750° C. and held at this temperature, and at a gas pressure near to atmospheric (0.1 MPa), for a period of 60 minutes. After cooling the ingot was removed from the mould and annealed in a separate furnace, and sections were then cut and ground for interferometry and birefiingence measurement. From these measurements it was evident that the sharp changes in refractive index due to the former existence of bubbles had been reduced in their intensity. The ingot had an acceptably low level of stress birefringence and was suitable for high quality optical applications, including the manufacture of photomask substrate plates.

### EXAMPLE 3

A further bubble-containing ingot was prepared by the direct deposition process as in Example 1. This was treated by hot isostatic pressing under the conditions outlined in Example 2 to remove the contained bubbles. The ingot was then machined to remove superficial devitrification, to produce a cylindrical body of dimensions diameter 315 mm and length 800 mm (weight 138 kg). The ingot was thoroughly cleaned and placed in a high purity graphite mould of internal diameter 440 mm, in a high temperature furnace. The internal surface of the mould was again coated with silicon carbide powder, as in Example 1. The furnace was evacuated and re-filled with argon, and then heated to a temperature of 1750° C. for a period of 60 minutes and held at this temperature for a period of 60 minutes and at a gas pressure near to atmospheric (0.1 MPa), when it flowed under gravity to fill the mould and form a glass body 440 mm diameter. After cooling the ingot was removed from the mould and annealed in a separate furnace, and sections were then cut and ground for interferometry and birefringence measurement. From these measurements there was no evidence of sharp changes in refractive index due to the former existence of bubbles. The ingot had an acceptably low level of stress birefringence and was of a high optical quality as required for the manufacture of photomask substrate plates.

It is thus clear that the secondary high temperature heat treatment was responsible for eliminating the homogeneity defects which remained after the hot isostatic pressing process. The flow of material which was a feature of Example 3, and was the result of flow of glass to form a product of larger cross-sectional area, is thought to have been beneficial in achieving homogenisation, but appears not to be essential. Significant upgrading in homogeneity was achieved simply by the high temperature secondary treatment with minimal flow, but it is probable that flow in the material is beneficial in achieving an improved overall homogeneity.

It is to be expected that a similar degree of flow and homogenisation would be achieved at somewhat lower temperatures if movement of the glass were to be promoted by the application of mechanical pressure on the surface of the glass, as might be achieved by applying pressure to a plate covering the surface, and forcing the softened glass into the interstices of the mould. Such a method is valuable in ensuring that on reshaping of the ingot the glass takes the exact form of the reshaping mould, i.e. filling all corners and leaving no voids. Reduction of the temperature used for the secondary heat treatment also has the merit of reducing the superficial contamination of the ingot, and minimising the amount of material which may have to be removed to achieve the desired optical properties.

While the above experiments demonstrate the conversion of a cylindrical ingot to a cylindrical form of large diameter, as required for the manufacture of one or more windows or lenses, it is evident that reshaping to an ingot of square or rectangular form would be equally feasible, and that the above process could thus be used to make a high quality bubble-free block of glass from which one or more LCD photomask substrates could be manufactured.

1. A process for the manufacture of a substantially bubble-free article of synthetic vitreous silica free from localised variations in refractive index (striae) and suitable for optical applications, wherein an ingot of synthetic vitreous silica containing unacceptable bubbles is submitted to a first heat treatment process consisting of hot isostatic pressing at a temperature in the range 1,250° C. to 1,500° C. at a pressure in the range 10 MPa to 250 MPa, followed by a second heat treatment process at a pressure in the range 0.01 to 1 MPa and at a temperature in the range 1,550° C. to 1,850° C.

2. A process as claimed in claim 1, wherein the first heat treatment process is carried out at a pressure in the range 50 to 120 MPa.

3. A process according to claim 1, wherein the second heat treatment process results in flow of said silica under gravity and the consequent reshaping of said ingot.

4. A process according to claim 3, wherein the second stage heat treatment process occurs in a mould permitting flow of said silica to form a product of larger cross-sectional area.

5. A process according to claim 1, wherein the secondary heat treatment takes place at a pressure in the range 0.01 to 1 MPa.

6. A process according to claim 1, wherein the ingot weight prior to hot isostatic pressing is more than 100 kg.

7. A process according to claim 1, wherein the ingot weight prior to hot isostatic pressing is more than 200 kg.

8. A process according to claim 1, wherein the ingot weight prior to hot isostatic pressing is more than 300 kg.

9. A process according to claim 1, wherein the product is of a quality suitable for the manufacture of one or more photomask substrate plates.

10. A substantially bubble-free article of synthetic vitreous silica, produced by a method according to claim 1.

11. A substantially bubble-free article of synthetic vitreous silica free from localised variations in refractive index (striae) and suitable for optical applications, manufactured by submitting an ingot of synthetic vitreous silica containing unacceptable bubbles to a first heat treatment process consisting of hot isostatic pressing at a temperature in the range 1,250° C. to 1,500° C. at a pressure in the range 10 MPa to 250 MPa, followed by a second heat treatment process at a pressure in the range 0.01 to 1 MPa and at a temperature in the range 1,550° C. to 1,850° C.

12. A substantially bubble-free article of synthetic vitreous silica, free from localised variations in refractive index (striae) and suitable for optical applications, formed from a hot isostatically pressed ingot.

13. An article according to claim 12, whose weight is greater than 25 kg.

14. An article according to claim 11, whose weight is greater than 245 kg.

15. An article according to claim 12, comprising an article selected from the list consisting of a window, a lens and a photomask substrate plate.

16. An article according to claim 11, comprising an article selected from the list consisting of a window, a lens and a photomask substrate plate.

17. An article according to claim 10, comprising an article selected from the list consisting of a window, a lens and a photomask substrate plate.

18. An article according to claim 10, whose weight is greater than 25 kg.

19. A process according to claim 1, wherein the second stage heat treatment process results in flow of said silica under the application of mechanical pressure and the consequent reshaping of said ingot.

20. A process according to claim 19, wherein the second stage heat treatment process occurs in a mould permitting flow of said silica to form a product of larger cross-sectional area.
